(19) United States
(12) Patent Application Publication
(10) Pub. No.: US 2013/0057665 A1
(43) Pub. Date: Mar. 7, 2013

(54) METHOD FOR MAKING VARIABLE REPRESENTATIVE CHARACTERISTICS OF (CUT) FLOWERS AND/OR ORNAMENTAL PLANTS ACCURATELY IDENTIFIABLE AND VISIBLE FOR CONSUMERS; AS WELL AS A SYSTEM WHICH IS SUITABLE FOR PERFORMING SUCH METHOD

(71) Applicant: Jorrit Koeman, Hem (NL)

(72) Inventor: Jorrit Koeman, Hem (NL)

(21) Appl. No.: 13/603,533

(22) Filed: Sep. 5, 2012

(30) Foreign Application Priority Data
Sep. 5, 2011 (NL) 1039023

(51) Int. Cl. G06K 9/20

(52) U.S. Cl. 348/61

(57) ABSTRACT

The invention relates to methods and systems making variable representative characteristic of (cut) flowers and/or ornamental plants accurate identifiable and visible to customers. A code (or copies thereof) are affixed to a set of flowers having a certain representative characteristic. A customer may use a device to obtain the code (e.g., via a scanner), and a request to obtain the representative characteristic is made. In some embodiments, the representative characteristic is provided to the user through a video of the life cycle of the flower and/or plant.

### CROSS-REFERENCE AND PRIORITY CLAIM TO RELATED APPLICATIONS

This application claims priority to Dutch Patent Application No. 1039023, filed Sep. 5, 2011, entitled “Werkwijze voor het voor consumenten nauwkeurig identificeerbaar en zichtbaar maken van variabele representatieve kenmerken van (snij)bloemen en/of sierplanten; alsmede een systeem dat geschikt is voor het uitvoeren van een dergelijke werkwijze” (English translation: Method for making variable representative characteristics of (cut) flowers and/or ornamental plants accurately identifiable and visible for consumers; as well as a system which is suitable for performing such method.) which application and any English translation are incorporated herein by reference and made a part hereof in its entirety.

### FIELD OF INVENTION

The disclosure generally relates to providing variable characteristics of flowers or plants to a buyer or consumer. In particular, though not necessarily, the disclosure relates to methods and systems for providing variable characteristics of flowers or plants to a consumer via a scannable or readable code.

### BACKGROUND

A consumer or buyer must be able to trust that the quality of his purchase, e.g., flower(s) or plant(s) is good. Various floral products have quality characteristics, such as ornamental value, vase life, shelf life and flower bud opening (e.g., size, duration), fragrance. The varying characteristics is no coincidence, since the growers can sometimes cultivate better varieties than others. How well and how long the products can last in the living room, e.g., vase life or shelf life, is strongly dictated by what the grower or breeder does.

Shelf life (or referred to as vase life for cut flowers) for consumers is an important aspect of the quality of flowers and plants. It gives insight on how the flowers and plants holds up and/or lasts at the consumer end. Shelf life and has become an integral part of, for example, quality marks or guarantee schemes. However, such specific and/or variable information is not readily available to buyers of flowers and/or plants. Or, if general shelf life for a variety of flowers is provided (e.g., “These Hollandia tulips will generally last for 7 days with flower food”), the information may not be accurate for the particular harvest of the variety. As a result, buyers and/or consumers cannot accurately and/or efficiently gauge the quality of a purchase.

### SUMMARY

These quality attributes or characteristics can differ, e.g., from harvest to harvest, from variety to variety, from mode of transportation (e.g., sea freight, air freight), with flower food or without flower food. Thus the quality attributes are highly variable and cannot be provided accurately by the general and/or static information for a particular variety of flowers. Especially in the categories of more expensive bouquets (e.g., having many relative expensive flowers and/or having a mix of flowers), it is very important that the quality characteristics of the specific flowers or bunches of flowers can be communicated to the consumer and adequately guaranteed by the growers or suppliers.

The shelf life or vase life of flowers can be determined on the basis of so-called shelf life testing (or blooming testing or flower blooming testing). These tests have been used to test the shelf life of flowers and/or plants. These indicate to companies (such as wholesalers) important information about, inter alia, the duration of the transportation and conditions in which the flowers and plants are transported. It also gives insight into matters such as botrytis, bloom time, flower bud opening, maturity, etc.

The Knowledge Centre of Product Quality of the FloraHolland has already performed 25 years of practical research into the shelf life and the blooming of flowers and plants. That research helps ensure that products that are traded via FloraHolland in an optimal state when the products reach the consumer. Accordingly, tests are performed on sets of flowers and/or plants from a particular harvest and a particular variety, such that accurate quality characteristics of a particular set can be known. For instance, a flower blooming test may be performed such that a video of the flower blooming cycle can be recorded. The video then provides an accurate indication to a buyer of the shelf life for the particular the set of flowers. While it is preferred that the video is recorded in a controlled setting, one skilled in the art may record the video through other suitable settings.

However, when a buyer and/or a consumer sees the set of flowers, it is not easy to look up the test results. The offer and the number of available varieties are growing fast, it is difficult or perhaps not even possible for a customer to be able to visually identify and/or distinguish the varieties. For this reason, a customer cannot make use of the centralized databases of variable quality characteristics. Especially for tulips, where more than 10,000 varieties are on the market, the identification of variety is not a task for a normal consumer. Yet at the same time, consumers and customers should be provided with quality characteristics clearly and accurately and the quality of the varieties and/or harvests should be distinguishable.

Furthermore, it is not always possible for the buyer and/or consumer to determine which grower had grown the variety and produced the particular harvest. The identifying information relating to a particular variety and/or harvest is not always provided to a buyer and/or a consumer, especially when the buyer and/or the consumer are at a supermarket, florist, market, gas station, wholesaler, do-it-yourself/hobby shop, or another informal place of purchase. At best, the buyer and/or customer are provided with general and/or static quality characteristics about the variety, which does not account for variations in quality characteristics from one harvest to another or from one grower to another. Accordingly, the buyer and/or the consumer cannot accurately identify the variety and the harvest to look up the variable test results, and thus cannot accurate gauge the quality from one set of flowers to another.

The present disclosure relates to a method for making variable representative features of (cut) flowers and/or ornamental plants accurately identifiable for consumers, as well as to a system that is suitable for performing this procedure. The present invention aims, for example, to give insight to the consumers on the specific shelf life of (cut) flowers and/or plants in the store, which may differ from variety to variety and from harvest to harvest. Through this method and the system of the invention, the suppliers of flowers and plants can distinguish themselves from each other. A (substantially unique) code that is suitable for machine detection (e.g., scan-able or readable by a device) is provided for a set of flowers and/or plants. When a user is in proximity to the flowers, the user may use the user device to obtain the code though the use of scanner/reader. The detected information may then be processed by a code detector (e.g., using image processing algorithms or other suitable signals processing algorithm) to extract the code (e.g., implemented as part of or with a software application running on the user device). The code and/or a derivation thereof may then be used to retrieve specific and variable quality characteristics about the set. Accordingly, the retrieved specific and variable quality characteristics may be rendered for display to the user, (e.g., through the software application running on the user device).

Furthermore, the (variable) quality characteristic may comprise a video, e.g., a blooming test conducted for the particular set of flower, representative of the blooming cycle and/or plant cycle of the product. The video information advantageously allows the user to visually gauge and/or compare the present state of the flowers (as the user sees it at the moment in time) against the frames of the video. As a result, the user can, on the basis of the video, accurately (and “on the spot”) determine the remaining shelf life and/or ripeness, i.e., value, of the product. Such advantage is not achieved when a user is only provided with general and static quality characteristics. In some embodiments, the variable quality characteristics may be used to supplement the general and static characteristics, and vice versa. For instance, the user may compare the difference between the variable quality characteristic of a particular harvest and a general characteristic of a variety. The user may give a particular set of flowers a higher value if the harvest has a higher quality variable characteristic than the general characteristic.

The ease of retrieval of variable quality characteristics associated with a particular set of relatively highly perishable goods having a shelf life, e.g., flowers and/or plants, advantageously provides a user with an opportunity to obtain specific and accurate information about the goods efficiently. Furthermore, by optionally providing a video of the life cycle of the goods (e.g., a time lapse video of a blooming test of flowers), the user is provided with visual information to enable the user to (visually) determine at which point/stage/phase the goods are in the life cycle. For instance, the video may be provided with additional information such as identifying information for the set of flowers to which the code specifies, and time code information which shows the timing information (e.g., time elapsed) associated with the frames/shots of the video.

The disclosure may also relate to a computer program product, implemented on computer-readable non-transitory storage medium, wherein the computer program product may comprise software code portions configured for, when run a computer, executing the method steps according to any of the methods described in the present disclosure. The computer program product is preferably implemented at least in part in any of the system components described herein.

The disclosure will further be illustrated with reference to the attached drawings, which schematically show embodiments according to the disclosure. It will be understood that the disclosure is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1 shows an illustrative system for providing variable representative features to a consumer;

FIG. 2 shows an illustrative system comprising a user device for scanning and/or reading a code; and

FIG. 3 shows various illustrative user interfaces and/or video shown to a user.

### DETAILED DESCRIPTION

Generally, methods are known by the application of so-called quick response (a QR code, a two-dimensional barcode), readable or scan-able by a mobile phone, during the purchase of seeds, trees, shrubs, animals or vegetables or fruit, to provide general and static information via the Internet to the purchaser regarding the purchased product. The static information typically provides general information about the variety/specie, the grower, the seller, etc. There are programs known wherein a buyer with a mobile phone can directly scan the QR code and then directly reach a website with static information about his purchase. This information is general and merely indicative in nature and is likely legally insufficient for the seller and the buyer to rely on this as a measure of the quality of the specific product to be sold. The method is neither accurate nor precise. Furthermore, these known methods are not applied on cut flowers and/or plants.

In addition, the quality characteristics differ from variety to variety and from harvest to harvest, thus the variable (representative) quality characteristics are not made identifiable and/or accessible with the known methods (since the general and static information is insufficient). The information is text oriented, and intentionally complex, likely making it so the consumer will not always be able to find the desired information.

No method has been known to the applicant, comprising of a combination of physical (technical) and software-based measures, for making variable quality characteristics representative of (cut) flowers and/or ornamental plants accurately identifiable and visible for consumers, via a (mobile) readable or scan-able code, to or on which is applied on the packaging of (cut) flowers and/or ornamental plants, regarding the variable (representative) quality characteristics (for example, on the basis of videos filming those flowers and/or plants representative blooming tests), made accessible by a mobile phone, and to offer control over the quality characteristics of the purchased (cut) flowers and/or ornamental plants. To applicant is no such method known, where all the desired information is shown in a very short time frame and efficiently to the consumer.

The disclosure therefore provides improved methods and systems for making variable characteristics (representative) of (cut) flowers and/or ornamental plants accurately identifiable and visible for consumers.

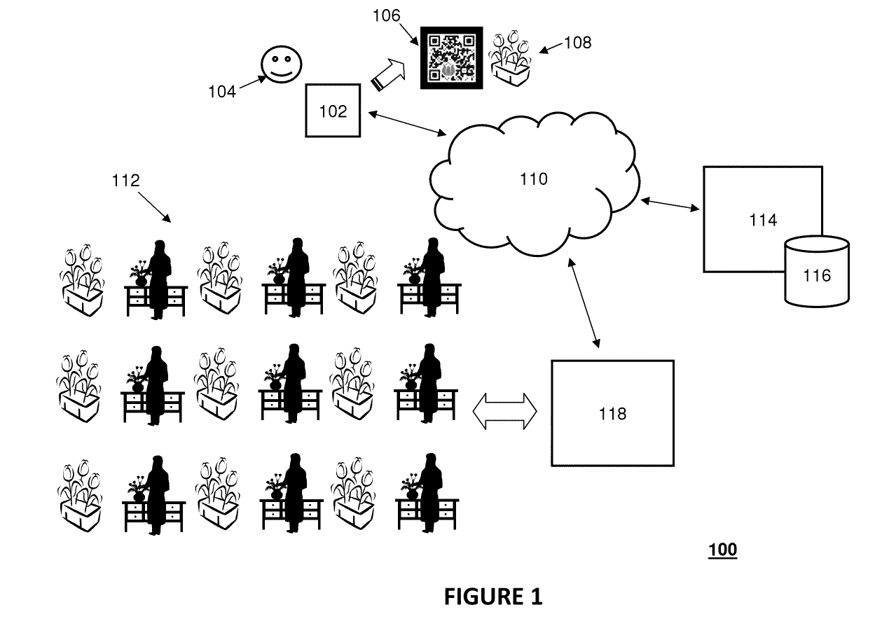

FIG. 1 shows an illustrative system for providing variable representative features to a consumer. In one embodiment, a set of flowers and/or plants are selected. The set may be assumed to have at least one specific and variable quality characteristic.

At the source or during a point of distribution, a particular set of flowers and/or plants (or other suitable highly perishable goods having a particular life time or life cycle) may be associated with a particular identifier. For instance, the identifier may substantially uniquely identify the variety, harvest, and/or grower, i.e., such that a set of flowers and/or plants substantially sharing a variable quality characteristic may be substantially identified. A subset from the set is tested, e.g., at a testing facility 118 to obtain (at least one) variable quality characteristics representative of the set (flowers and testers 112).

At the source or during a point of distribution, a substantially unique code (or another appropriate code that can be scanned or recognized with a mobile phone, for example) may be affixed to or onto the set of flowers or plants and/or the flower packaging. The code enables the look up of quality characteristics associated with a set of flowers having the particular identifier. In other words, the code enables the retrieval of information associated with the particular set of flowers without requiring the user to visually determine and input the variety and/or harvest the set belongs.

The variable quality characteristics of that set of flowers and/or plants may be stored at a computer server 114 (or a distributed server system). The characteristics may be obtained from, such as, conducting one or more representative blooming tests. The characteristics may be stored/maintained in a database 116 of the computer server. The characteristics may be associated with the particular identifier and/or the code. For instance, the characteristics may be updated for the particular set of flowers.

When a buyer or customer 104 (or a user) is in proximity to the flower and/or plant 108 having the code 106 affixed thereon, the user is provided with online (or mobile or wireless or remote) access to the one or more variable representative quality characteristics, by transmitting the code (or another appropriate code that can be read or scanned, for example with a mobile phone or any suitable user device 102) and/or a derivation thereof as a request to the computer server over a communication network 110. The communication network may be, e.g., the Internet, a local area network, a wireless network, a wired network, a mobile phone network, and/or any suitable communication network configured to enable requests and responses to be transmitted between the user device and the computer server (e.g., via a communication module of the computer server).

In response, the computer server looks up in the database for the one or more quality characteristics associated with that set of flowers and/or plants using the received code and/or a derivation thereof. Upon locating the quality characteristic(s), the computer server transmits the characteristics to the user device, e.g., over the network, such that the characteristics may be rendered for display to the user. As a result, the user is able to obtain specific and variable quality characteristics accurately and efficiently for a particular set of flowers.

The disclosure further discloses a system which is suitable for performing this method. In some embodiments, a central computer, may be a platform and/or a computer server, wherein content is accessible by a device remote to the central computer. For instance, the central computer may provide access for a user device to obtain stored characteristics related to a plurality of sets of flowers from the central computer. In some instances, a website configured to display characteristics associated with a particular set of flowers is made accessible to a user device, e.g., via a mobile network or wireless network.

The system may further include one or more (cut) flower(s) and or ornamental plant(s), where or to whom (or to the flower packaging) a unique QR code (or another appropriate code, for example that can be scanned with a mobile phone) is affixed. In some embodiments, the system further includes test facilities for performing testing to obtain variable characteristics representative of a set of flowers to which the one or more flowers belong. In some embodiments, the system comprises a user device, such as a mobile phone, that is equipped with a program, hardware, and/or a code detector that allows the QR code (or other appropriate code that can be scanned with a mobile phone) to be detected/recognized.

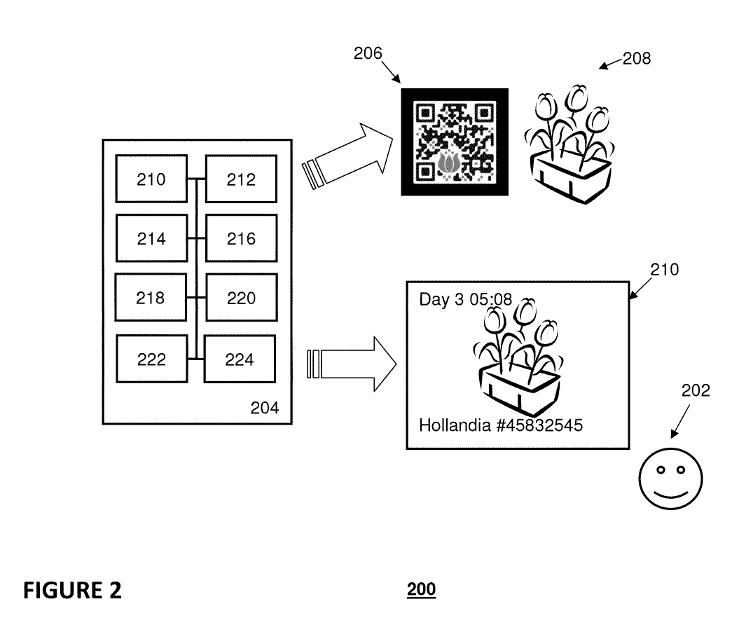

FIG. 2 shows an illustrative system comprising a user device for scanning and/or reading a code. To enable access to the variable characteristics representative of flowers and/or plants 208, a user 202 is provided with a user device 204. The user device is configured to recognize (e.g., scan, read, and/or detect) code 206 that is affixed to the flowers and/or plants. The user device is preferably mobile such that a user may move at least part of the device. Such a user device, e.g., a handheld scanner, a handheld tablet, a handheld device, or a device having such handheld devices, enables the user to move around freely and/or with ease while using the system. In some embodiments, the user device is fixed and/or stationary, but the flowers and/or plants are movable so that the code can be scanned at the user device.

Because it is relatively difficult and inefficient for the user to accurately determine the variety and/or the harvest of the flowers, the user device advantageously provide technical means to enable a user to accurately identify the flowers such that the specific variable characteristics may be obtained. In this embodiment, the user device may include a processor 210, a non-transient computer memory/storage 214, a communication module 218, a user input part 220, an output part 224. Various parts of the user device may be physically packaged in a single device, or may be implemented in a distributed manner. Nonetheless, the various parts are preferably communicably connected to each other via a communication bus and/or other communication channels.

The processor is configured to execute computer program instructions, e.g., stored in the memory, for running software applications. The communication module enables the user device to communicate with, e.g., a computer server in which the variable quality characteristics are stored. The user input part may include a microphone, a touch-sensitive surface, a keypad, a scroll button, a scroll ball, a digital imaging device, a light sensor, and/or any suitable user input technologies. The output part may include at least one of a (digital) display device, one or more speakers, haptic output, and/or any suitable output technologies. The output part is advantageously provided with the user device, and/or the output device is provided at a location remote from the user device (e.g., a display output in communication with the user device may be provided over a narrowcasting network.)

The user device is also configured such that the identification of the set of flowers may be used to obtain and output the specific variable characteristics to the user. The identification of the set of flowers is advantageously provided by a code affixed to the flowers. In some embodiments, a scanner part 212 is provided for scanning and/or reading the code. The scanner part may include a digital imaging device such as a digital camera, for capturing an image of the code. In some embodiments, the scanner part may include a laser barcode scanner for determining a pattern represented by the code. In some cases, the scanner part may include an antenna receiving a signal transmitted from the code (e.g., a flexible circuit embedded with a sticker). Once the scanner part has scanned or read the code, a code detector 216 may be provided to determine/extract the code itself and/or a derivation of the code. For instance, the code detector may include an image processing algorithm for processing a digital image to extract the code from the digital image. The code detector may include an object/image recognition system for extracting features from a digital image and matching the extracted features with reference features of known objects/images. In certain embodiments, at least part of the code detector may be implemented on the computer server to reduce the amount of computational resources needed at the user device. Accordingly, the output of the scanner part may be transmitted over a network to the computer server for further processing (i.e., code detection).

By rendering the video of the blooming test for display, the user viewing the video from the display output of the user device can visually compare the present state of the flowers against the various stages of the life cycle shown in the video. As a result, the user is able to accurately, on the basis of the video, (visually) determine the remaining shelf life of the set of flowers, or other variable quality characteristics. The video information is preferably short in duration, of 10-15 seconds approximately, to quickly show the life cycle of the flowers to the user without losing the user's interest in the video. A video player may be provided on the user device such that playback options, e.g., pause, repeat, rewind, fast forward, stop, etc., can be selected by the user through the user input part to control the blooming video.

Variable representative characteristics of (cut) flowers and ornamental plants within the framework of the present invention means that the characteristics, such as the shelf life, may vary from harvest to harvest, and therefore are variable. This is emphatically not static and general information, since static and general information does not make variable representative characteristics of (cut) flowers and/or ornamental plants are made visible and identifiable to the consumer. The variable representative quality attributes can in fact be any technical characteristics of a particular set of flowers and/or plants, such as the ornamental value, vase life, shelf life and/or flower bud opening. One skilled in the art knows these attributes.

In the context of this disclosure, accurate testing is carried out with measurements, e.g., from harvest to harvest, which are to not necessary representative for all flowers or plants belonging to a class. Sets of flowers or plants on the basis of product can be identified and described by various characteristics, which are known to one skilled in the art.

As a measure of the shelf life of flowers and/or plants, mostly blooming tests are performed. Performing such blooming tests, such as those according to the disclosure, is known in the state of the art. Because this invention makes use of the representative flower blooming tests, and the consumer can access the variable representative data via the code for a bouquet, it is possible to provide a specific quality guarantee on a bouquet or plant being offered.

In some embodiments, the video from the blooming tests is provided as the variable quality characteristic from a computer server to the user device. A graphics module 222 of the user device is configured render the video for display to the user through the output part. An exemplary frame from the video 210 may depict the life cycle of the perishable goods. In some embodiments, identifying information for the particular set of goods having the variable quality characteristic is rendered for display (e.g., simultaneously). In some embodiments, the timing information, e.g., time code, of the blooming test is displayed (e.g., simultaneously during the duration of the blooming test video). The composite of video and other additional information regarding the particular set of flowers may be generated at the testing facility, the computer server, the graphics module of the user device, and/or any combination thereof.

The conditions in which the flowers or plants are tested (for example in a canteen or office) are preferably as constant as possible. Guidelines for shelf life research, under controlled climatic conditions, are:
a temperature of 20° C.±1° C.;
a relative humidity between 60 and 70%;
a light level of 1000 lux (table height) for 12 hours (and 12 hours dark);
no direct sunlight;
no trip/transport;
regular ventilation;
free from exhaust gases and smoke and away from vegetable/fruit.

The more flowers or plants used for the test, the more accurate picture is obtained for the shelf life during the test time. The cut flowers or plants are preferably harvested from places spread across the cultivation area.

For the assessment of cut flowers and plants, the Dutch Flower Auctions Association has developed assessment maps. There are general assessment maps for cut flowers and plants that indicate on what aspects of the products can be assessed. In addition, there are a number of directives on the maps in the implementation of the research. For a number of products, there are also specific assessment cards, which examines deeper on the aspects of the product which play a role in the shelf life.

The tests should always work with clean vases. After the end of the test, the vases must be washed with soapy water and rinsed well with hot water (or possibly two hours with chlorine solution after the rinse). Preferably, the vases used have a height of at least one third of the stem length. If flower food is used, the brand choice and proper dosage should be considered. The brand of the flower food and the dosage influence the shelf life at the consumer. When testing of cut flowers, it is important, prior to the start of the consumer phase, to cut off the stems or cut with a sharp pruning shears or a sharp knife. The stem should have as little damage as possible. Preferably, alcohol or methylated spirit is used for the cleaning of pruning scissors or knife for shearing/cutting off the stems.

When the research is completed, the results are processed. For example, the average shelf life and other relevant results can be listed on an assessment can form. Together with the information of the dataloggers, there is a complete list of the research conducted and the results, associating a set of flowers (e.g., by its identifier) with the variable quality characteristics. Such information is then stored on a computer server, e.g., organized in a database. A short report may state, start date, product description (cultivar, sorting, number of stems/plants, or any identifying information or identifiers), and duration and conditions marketing simulation duration and conditions consumer phase. The videos and possibly the other results (for example, average durability, comments about flowering, comments on leaf quality, photos from the research) can also be stored as variable representative features.

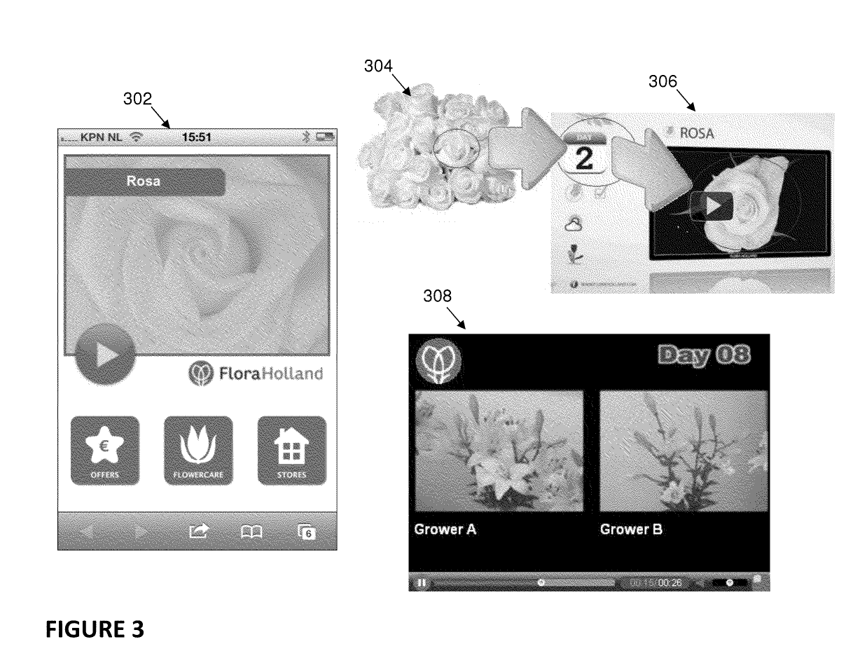

The flower blooming test produces visual information to make the quality visible to the user directly, e.g., at the point of evaluation and/or purchase as the user is in proximity to the product. FIG. 3 shows various illustrative user interfaces and/or video shown to a user. Screen 302 shows an exemplary user interface provided, e.g., as a software application running on the user device, where a user may view the video from the flower blooming test with a video player and other information may also be made accessible to the user through the user interface.

By providing the user with the video, a direct comparison between the present/current state of the highly perishable product and the different stages of the life cycle shown in the video can be made. Such a direct comparison enables the user to determine the state of his/her purchase. For instance, by looking at flowers 304, the user can compare the current state of the purchase to the video shown in user interface 306, where the expected state of the purchase associated with a particular duration of time is shown through the user interface. As a result, the user may, e.g., see that the roses are already two days old. If the user still decides to purchase the two day old roses, then the user is (legally) informed that the roses will have a shorter shelf life and, e.g., cannot claim a guarantee for the entire duration of the shelf life.

In general, flower blooming videos may be stored in various ways, which later can be shown to the consumer:
the flower blooming video can be recorded and/or shown in two-dimensional (high definition) images; and/or
the flower blooming video can be recorded and/or shown in three-dimensional (high definition) images; and/or
the flower blooming video can also be displayed and/or recorded as content suitable for display in augmented reality (e.g., Layar). With augmented reality, a virtual layer having the content may be created, and the layer may be rendered and projected onto the real world, causing the real world to be enhanced with digital information. For instance, the virtual layer may be super imposed onto a camera view and/or vision field of the real world.

To give the consumer access to the results of the flower blooming tests or to the flowers or plants (at least on or to the packaging thereof) a suitable code scan-able with a mobile phone is applied and/or affixed to the goods. The code on or to which the (cut) flowers and/or plants or their packaging is made may relate to different kinds of (bar) codes:
barcode; and/or
QR code; and/or
code embedded in electronic chips (e.g., flexible electronics) detectable through near field communication; and/or
images or objects suitable for image and/or object recognition.

In a detailed form of the methods and systems, a flower blooming video of a condensed representation of a flower/plant cycle is used. This can be made by:
on well-known manner make a movie/video of the life cycle of a plant or a flower; and/or
time lapse photography and/or video shoot of a plant and/or plant cycle, and then compressing these photos or video shots to video (i.e., a video sequence of frames); and/or video shoot of a plant cycle and/or product cycle (these images then are compressed into a video); and/or
a video shoot of a plant cycle and/or product cycle (this video can then be played back to the user at an accelerated rate).

Above photos and video shots may be carried out by means of “dolly shots”, wherein a camera is mounted on a dolly (tracks) to provide a video that shoots the product from various angles and/or distances to provide a comprehensive view of the product.

Furthermore, 1-click application is possible, whereby the scanning of the code triggers (with no or little user input) a blooming video e.g., of 10-15 seconds in duration, to be rendered for display to the user with additional information in, e.g., text and/or audio format (such as identifying information, variable quality characteristics, and timing information), in a custom made format simultaneously with the video. Advantageously, the consumer is able to obtain variable quality characteristics with ease and efficiency.

In the store, consumers can therefore via his mobile phone directly obtain relevant (technical) information regarding the bunches of flowers or plants which he is considering to purchase. Another application of this invention is to support a quality guarantee. If the consumer, after consulting the flower blooming tests by scanning, with his cell phone, the code affixed on or to the flowers or plants (at least on or to the packaging thereof), sees that its flowers finish blooming (much) earlier than the indicated according to flower blooming test, the supplier or seller can be offered that the consumer obtains a replacement bouquet.

In another situation, a video of more than one flower blooming tests comparing the different variable quality characteristics belonging to different sets of flowers may also be shown to the user, as seen in screen 308. In some embodiments, a video of more than one variable quality characteristics belonging to the same set of flowers may be shown to the user. The user interface may include any number of combinations of these features. Accordingly, the plurality of information provided to the user enables the user to make comparisons between sets of flowers with ease, and in some cases visually inspect more than one quality characteristic at the same time.

The invention also concerns a system that allows the working method of the present invention can be executed. This includes at least: a central computer at least a platform, allowing a website via a mobile network is available, test facilities for performing testing to obtain representative data, one or more (cut) flower (s) and or ornamental plant (and), where or to whom (or to the flower packaging) a QR code (or another appropriate code) is made, and, optionally, a mobile phone that is equipped with a program that allows the QR code (or other appropriate code) canto be recognized.

Of course, there are the obvious variants possible at the present invention, such as the manner of showing the flower blooming video shown to the consumer, the use of another code and/or the affixing of the code or on the products in a certain manner. Such variants that one skilled in the art can forsee are within the scope of this invention.

For example, a flower blooming film as a quality characteristic may be linked to a digital trading platform for flowers & plants. This digital trading platform (e-trade) is accessible via internet and/or mobile phone. As the flowers and/or plants passes by a scanner, the variable quality characteristic information may be obtained and displayed to the people participating in the auction.

Also, the flower blooming film may be provided to the user through a phone app for viewing flower blooming videos. This application is phone-based or web-based. Further flower blooming videos may be accessible without barcodes or QR codes.

The methods and systems relating to having a video as a variable quality characteristic, may include a time lapse video of at least one of: flower(s), plant(s), herb(s), grass(s), bush(s), tree(s), seeds(s), mold(s), fungus(s), and any other suitable vegetation.

The methods and systems disclosed herein may be used for one or more of the following exemplary (cut) flowers and/or plants: roses, tulips, Dianthus, Chrysanthemum, Gerbera, Alstroemeria, Freesia, lilium, Zantedeschia, Lisianthus, Gypsophila Lakanthurium, Iris, gladiolus, Hyacinths, Hydrangeas, Kalanchoe, Phalaenopsis, Dracaena, Dracaena, Anthurium, Ficus, Spathyphyllum, Hedera, Hydrangea macrophylla, Pelargonium, Viola, Buxus, Fuchsia, Petunia, Osteospermum, Cupressus, Skimmia, Calluna, Lobelia or Dahlia. As understood by one skilled in the art, the methods and systems may be applicable for other highly perishable goods, such as meat, vegetables, fruit, etc.

The methods and systems disclosed herein may be used not only in a business to consumer setting, but also in other settings such as: business to business, special trading platforms, webshops, e-trading platforms, grower to retailer, grower to exporter, and exporter to florist, etc.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored.

It is to be understood that any feature described in relation to any one embodiment may be used alone, or in combination with other features described, and may also be used in combination with one or more features of any other of the embodiments, or any combination of any other of the embodiments. Moreover, the invention is not limited to the embodiments described above, which may be varied within the scope of the accompanying claims.

1. Method for making one or more quality characteristic of a set of vegetation, such as flowers and/or plants, accurately identifiable and visible to a person using a user device, wherein a substantially unique code or copies thereof is affixed to the set of flowers and/or plants and/or a packaging for the set of flowers and/or plants, said method comprising:
(i) storing one or more quality characteristics with that set of vegetation, wherein one or more quality characteristic is obtained by conducting one or more representative blooming tests on a subset of the set of vegetation;
(ii) associating the stored one or more variable quality characteristic with the code or an identifier of the code in a database;
(iii) receiving a request for the one or more quality characteristics, wherein the request comprises the code and/or the identifier of the code, and the code and/or the identifier of the code is obtained by a code detector in a user device;
(iv) transmitting the one or more quality characteristics to the user device in response to the request.

2. The method according to claim 1, wherein conducting the representative blooming tests is carried out by recording a video of the set of vegetation.

3. The method according to claim 1, wherein the one or more quality characteristics comprises:
two-dimensional (high definition) images; and/or
three-dimensional (high definition) images; and/or
video content suitable for display in augmented reality through the user device.

4. The method according to claim 1, further comprising rendering the one or more quality characteristics for display to the user on a display part of the user device, and/or on a display of a narrowcasting network of displays.

5. The method according to claim 1, wherein the one or more quality characteristics comprises a blooming video of a shortened representation of a flower/plant cycle.

6. The method according to claim 1, wherein the one or more quality characteristics comprises:
a video of the life cycle of a plant or a flower; and/or
a time-lapse photography and/or video shoot of a plant and/or plant cycle and wherein the video is a compression of these photos or video shots; and/or
a video shoot of a plant and/or plant cycle, wherein the video is accelerated when played back on the user device.

7. The method according to claim 1, wherein the one or more quality characteristics comprises film shots recorded using a dolly.

8. The method according to claim 5, further comprising:
providing an application on the user device for rendering a blooming video with additional information substantially simultaneously for display to the user, for a duration of about 10 to 15 seconds.

9. The method according to claim 1, wherein the code on comprises at least one of the following and/or a derivation of one of at least one of the following:
barcode;
quick response (QR) code;
a code embedded within electronics suitable for near field communication; and
image data suitable for image and/or object recognition or a derivation thereof.

10. A system for making one or more quality characteristic of a set of vegetation accurately identifiable and visible to a person using a user device, wherein a substantially unique code or copies thereof is affixed to the set of vegetation and/or a packaging for the set of vegetation, said system comprising:
a computer server for:
(i) storing one or more quality characteristics with that set of vegetation in a database in the computer server, wherein one or more quality characteristic is obtained by conducting one or more representative blooming tests on a subset of the set of vegetation;
(ii) associating the stored one or more variable quality characteristic with the code or an identifier of the code in the database;
(iii) receiving a request through a communication module of the computer server for the one or more quality characteristics, wherein the request comprises the code and/or the identifier of the code, and the code and/or the identifier of the code is obtained by a code detector in a user device;
(iv) transmitting to the user device, using the communication module of the computer server, the one or more quality characteristics in response to the request.

11. The system according to claim 10, wherein conducting the representative blooming tests is carried out by recording a video of the set of vegetation.

12. The system according to claim 10, wherein the one or more quality characteristics comprises:
two-dimensional (high definition) images; and/or
three-dimensional (high definition) images; and/or
video content suitable for display in augmented reality through the user device.

13. The system according to claim 10, further comprising:
a graphics module for rendering the one or more quality characteristics for display to the user on a display part of the user device, and/or on a display of a narrowcasting network of displays.

14. The system according to claim 10, wherein the one or more quality characteristics comprises a blooming video of a shortened representation of a flower/plant cycle.

15. The system according to claim 10, wherein the one or more quality characteristics comprises:
a video of the life cycle of a plant or a flower; and/or
a time-lapse photography and/or video shoot of a plant and/or plant cycle and wherein the video is a compression of these photos or video shots; and/or
a video shoot of a plant and/or plant cycle, wherein the video is accelerated when played back on the user device.

16. The system according to claim 10, wherein the one or more quality characteristics comprises film shots recorded using a dolly.

17. The system according to claim 14, further comprising:
an application on the user device for rendering a blooming video with additional information substantially simultaneously for display to the user, for a duration of about 10 to 15 seconds.

18. The system according to claim 10, wherein the code on comprises at least one of the following and/or a derivation of one of at least one of the following:
barcode;
quick response (QR) code;
a code embedded within electronics suitable for near field communication; and
image data suitable for image and/or object recognition or a derivation thereof.

19. A user device for providing one or more quality characteristic of a set of vegetation to a person in an accurately identifiable and visible manner,
wherein a substantially unique code or copies thereof is affixed to the set of vegetation and/or a packaging for the set of vegetation,
wherein one or more quality characteristics with that set of vegetation is stored in a database in a computer server,
wherein one or more quality characteristic is obtained by conducting one or more representative blooming tests on a subset of the set of vegetation,
wherein the stored one or more variable quality characteristic is associated with the code or an identifier of the code in the database;
said user device comprising:
a code detector for detecting the code when the user is in proximity to the set of vegetation;
a communication module for:
(i) transmitting a request to the computer server for the one or more quality characteristics, wherein the request comprises the code and/or the identifier of the code, and the code and/or the identifier of the code is obtained by a code detector in a user device;
(ii) receiving the one or more quality characteristics in response to the request.

20. The user device according to claim 19, further comprising a graphics module for rendering the one or more quality characteristics for display, wherein the one or more quality characteristics comprises:
two-dimensional (high definition) images; and/or
three-dimensional (high definition) images; and/or
video content suitable for display in augmented reality through the user device.
